(19) United States
(12) Patent Application Publication
(10) Pub. No.: US 2016/0349418 A1
(43) Pub. Date: Dec. 1, 2016

(54) Color Filter Substrate, Color Filter, Display Panel and Display Device

(71) Applicant: Shenzhen China Star Optoelectronics Technology Co., Ltd., Shenzhen, Guangdong (CN)

(72) Inventor: Feng ZHAO, Shenzhen, Guangdong (CN)

(73) Assignee: Shenzhen China Star Optoelectronics Technology Co., Ltd., Shenzhen, Guangdong (CN)

(21) Appl. No.: 14/407,936

(22) PCT Filed: Nov. 21, 2014
(86) PCT No.: PCT/CN2014/091894

§ 371 Date: Dec. 12, 2014

(30) Foreign Application Priority Data
Nov. 18, 2014 (CN) 201410660260.1

(51) Int. Cl. G02B 5/20; G02F 1/1335

(52) U.S. Cl. CPC G02B 5/201; G02F 1/133516; G02F 2001/133519

(57) ABSTRACT

The invemtion discloses a color filter substrate. The color filter substrate includes a plurality of pixels arranged in an array, and each of the pixels at least includes a first sub-pixel, a second sub-pixel, a third sub-pixel and a fourth sub-pixel. The first sub-pixel is coated with a first color photoresist, the second sub-pixel is coated with a second color photoresist, and the third sub-pixel is coated with a third color photoresist. A photoresist of the fourth sub-pixel is formed by stacking any two of the first color photoresist, the second color photoresist and the third color photoresist. The present invention also provides a color filter, a display panel and a display device. They all are capable of increasing the color gamut, simplifying the production process, increasing productivity and reducing costs.

### BACKGROUND OF THE INVENTION

Field of the Invention

The present invention relates to an image display area, in particular to a color filter substrate, a color filter, a display panel and a display device.

Description of Related Art

In a color LCD panel, each pixel is composed of three liquid crystal sub-pixels, wherein the sub-pixels are respectively coated with red, green, or blue photoresists. Thus, light through the different sub-pixels can be displayed in different colors on the screen.

The traditional three-color pixels use red, green, and blue as primary colors. Each primary color has 256 kinds of strength. A variety of colors of light are formed by mixing the three colors. For example, because yellow is mixed by red and green light, you need to open two sub-pixels at the same time. This approach is narrower color gamut and higher power consumption.

The conventional four-color pixels add a photoresist to the original red, green, and blue color photoresists, to form four photoresists. A variety of colors of light are formed by mixing the four colors. However, due to add a color photoresist, complicate fabrication, decrease productivity, and rise material costs.

### SUMMARY OF THE INVENTION

The present invention provides a color filter substrate, a color filter, a display panel and a display device capable of increasing the color gamut, simplifying the production process, increasing productivity and reducing costs.

To solve the above technical problems, an embodiment of the present invention provides color filter substrate. The color filter substrate includes a plurality of pixels arranged in an array, and each of the pixels at least includes a first sub-pixel, a second sub-pixel, a third sub-pixel and a fourth sub-pixel. The first sub-pixel is coated with a first color photoresist, the second sub-pixel is coated with a second color photoresist, and the third sub-pixel is coated with a third color photoresist. A photoresist of the fourth sub-pixel is formed by stacking any two of the first color photoresist, the second color photoresist and the third color photoresist.

Wherein, the first color photoresist, the second color photoresist and the third color photoresist respectively use a red photoresist, a green photoresist and a blue photoresist to allow red light, green light and blue light respectively to pass through the first sub-pixel, the second sub-pixel and the third sub-pixel, and the photoresist of the fourth sub-pixel formed by stacking any two of the first color photoresist, the second color photoresist and the third color photoresist allows the corresponding one of yellow light, purple light and cyan light to pass through the fourth sub-pixel.

Wherein, the fourth sub-pixel is formed by stacking the photoresist of the first sub-pixel and the photoresist of the second sub-pixel.

Wherein, the first sub-pixel, the second sub-pixel, the third sub-pixel, and the fourth sub-pixel are in the same row or the same column.

Wherein, the fourth sub-pixel are located between the first sub-pixel and the second sub-pixel.

Wherein, the the first sub-pixel, the second sub-pixel, the third sub-pixel, and the fourth sub-pixel form a square.

Wherein, the first sub-pixel and the second sub-pixel are located on a diagonal line of the square.

Wherein, each of the pixels further includes a fifth sub-pixel and a sixth sub-pixel. The fifth sub-pixel and the sixth sub-pixel are formed by stacking any two of the first color photoresist, the second color photoresist and the third color photoresist to allow the corresponding one of yellow light, purple light and cyan light to pass through the fifth and sixth sub-pixels, and the fourth pixel, the fifth sub-pixe and the sixth sub-pixel are different one another.

Wherein, the first sub-pixel, the second sub-pixel, and the third sub-pixel are in the same row or the same column;

Wherein, the fourth sub-pixel is formed by stacking the photoresist of the first sub-pixel and the photoresist of the second sub-pixel, the fifth sub-pixel is formed by stacking the photoresist of the second sub-pixel and the photoresist of the third sub-pixel, and the sixth sub-pixel is formed by stacking the photoresist of the third sub-pixel and the photoresist of the first sub-pixel located in another pixel.

Wherein, the first sub-pixel, the second sub-pixel, the third sub-pixel, the fourth sub-pixel, the fifth sub-pixel, and the sixth sub-pixel are arranged in two columns and three rows, three columns and two rows. The fourth sub-pixel is formed by stacking the photoresist of the first sub-pixel and the photoresist of the second sub-pixel, the fifth sub-pixel is formed by stacking the photoresist of the second sub-pixel and the photoresist of the third sub-pixel, and the sixth sub-pixel is formed by stacking the photoresist of the third sub-pixel and the photoresist of the first sub-pixel.

To solve the above technical problems, another embodiment of the present invention provides a color filter. The color filter includes a plurality of pixels arranged in an array, and each of the pixels at least includes a first sub-pixel, a second sub-pixel, a third sub-pixel and a fourth sub-pixel. The first sub-pixel is coated with a first color photoresist, the second sub-pixel is coated with a second color photoresist, and the third sub-pixel is coated with a third color photoresist. A photoresist of the fourth sub-pixel is formed by stacking any two of the first color photoresist, the second color photoresist and the third color photoresist.

Wherein, the first color photoresist, the second color photoresist and the third color photoresist respectively use a red photoresist, a green photoresist and a blue photoresist to allow red light, green light and blue light respectively to pass through the first sub-pixel, the second sub-pixel and the sub-pixel, and the photoresist of the fourth sub-pixel formed by stacking any two of the first color photoresist, the second color photoresist and the third color photoresist allows the corresponding of yellow light, purple light and cyan light to pass through the fourth sub-pixel.

Wherein, the fourth sub-pixel is formed by stacking the photoresist of the first sub-pixel and the photoresist of the second sub-pixel.

Wherein, the first sub-pixel, the second sub-pixel, the third sub-pixel, and a fourth sub-pixel are in the same row or the same column.

Wherein, the fourth sub-pixel are located between the first sub-pixel and the second sub-pixel.

Wherein, the the first sub-pixel, the second sub-pixel, the third sub-pixel, and the fourth sub-pixel form a square.

Wherein, the first sub-pixel and the second sub-pixel are located on a diagonal line of the square. To solve the above technical problems, another embodiment of the present invention provides a display panel. The display panel includes a color filter substrate and an array substrate. The color filter substrate includes a plurality of pixels arranged in an array, and each of the pixels at least includes a first sub-pixel, a second sub-pixel, a third sub-pixel and a fourth sub-pixel. The first sub-pixel is coated with a first color photoresist, the second sub-pixel is coated with a second color photoresist, and the third sub-pixel is coated with a third color photoresist. A photoresist of the fourth sub-pixel is formed by stacking any two of the first color photoresist, the second color photoresist and the third color photoresist.

Different from the case of the prior art, the invention is by stacking any two of the conventional three color photoresists in each pixel to form the fourth color photoresist. The fourth color photoresist can allow a fourth color to pass through the photoresist so as to increase the LCD's color gamut. Furthermore, the fourth color photoresist is formed by stacking the conventional three color photoresists, adding no new photoresist, simplifying the production process, improving production efficiency, and reducing costs.

### BRIEF DESCRIPTION OF THE DRAWINGS

FIG. 1 is a schematic structural view of a color filter substrate of the first embodiment of the invention.

FIG. 2 is a schematic structural view of a color filter substrate of the first embodiment of the invention formed by stacking two photoresists to form four photoresists.

FIG. 3 is a schematic structural view of a color filter substrate of the first embodiment of the invention formed by stacking three photoresists to form six photoresists.

FIG. 4 is a schematic structural view of a color filter substrate of the second embodiment of the invention formed by stacking the red and green photoresists of the red, green and blue color photoresists.

FIG. 5 is a schematic structural view of a color filter substrate of the second embodiment of the invention formed by stacking any two of the red, green and blue color photoresists.

FIG. 6 is a schematic structural view of four color photoresists of a color filter substrate of the third embodiment of the present invention.

FIG. 7 is a schematic structural view of six color photoresists of a color filter substrate of the third embodiment of the present invention.

FIG. 8 is a schematic structural view of a color filter of the first embodiment of the invention.

FIG. 9 is a schematic structural view of a display panel of the first embodiment of the invention.

FIG. 10 is a schematic structural view of a display device of the first embodiment of the invention.

### DESCRIPTION OF THE EMBODIMENTS

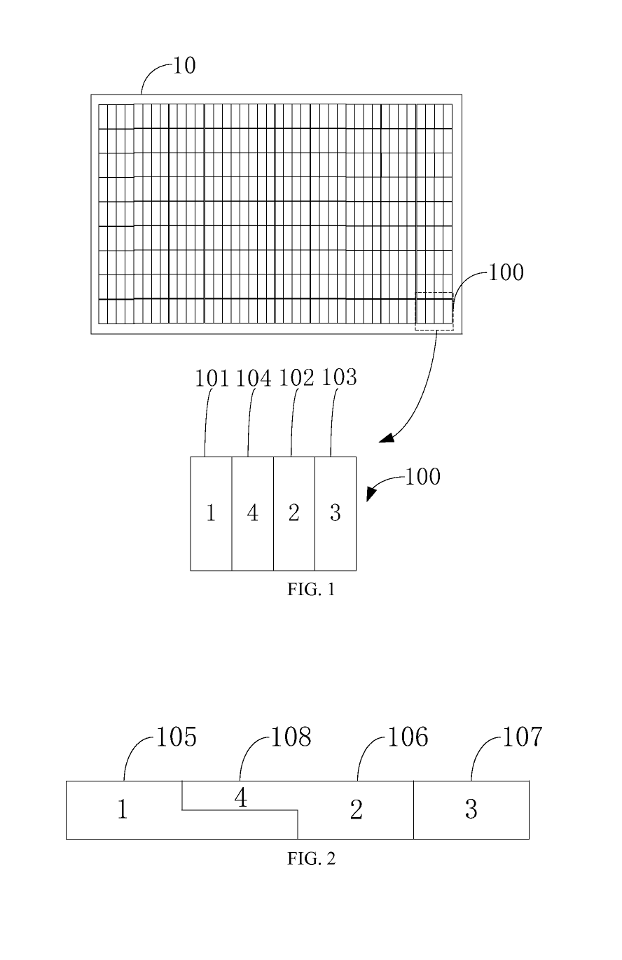

Please refer to FIG. 1, a schematic structural view of a color filter substrate of the first embodiment of the invention. The color filter substrate 10 includes a plurality of pixels 100 arranged in an array, and each of the pixels 100 at least includes a first sub-pixel 101, a second sub-pixel 102, a third sub-pixel 103 and a fourth sub-pixel 104.

Please refer to FIG. 2 at the same time. The first sub-pixel 101 is coated with a first color photoresist 105, the second sub-pixel 102 is coated with a second color photoresist 106, and the third sub-pixel 103 is coated with a third color photoresist 107. A photoresist of the fourth sub-pixel 104 is formed by stacking any two of the first color photoresist 105, the second color photoresist 106 and the third color photoresist 107.

The shapes and size ratios of the first sub-pixel 101, a second sub-pixel 102, a third sub-pixel 103 and the fourth sub-pixel 104 may be adjusted as needed.

The colors of the first color photoresist 105, the second color photoresist 106 and third color color photoresist 107 can be set, generally using red, green, and blue color to mix more colors.

Specifically, when the light is incident on each sub-pixel, by the action of the photoresists, each photoresist makes the same color of light with its color pass, and the stacked photoresist makes the same color of light pass with the mixed color by stacking two photoresist colors.

Further, each pixel 100 may also be formed with five, six or even a plurality of sub-pixels. With six sub-pixels, for example, as described in FIG. 3, each pixel 100 still requires only three color photoresists, i.e., a first color photoresist 105, a second color photoresist 106 and the third color photoresist 107. The first color photoresist 105 and the second color photoresist 106 are stacked to form a fourth color photoresist 108. The second color photoresist 106 and the third color photoresist 107 are stacked to form a fifth color photoresist 109. The third color photoresist 105 and the first color photoresist of the next piexl are stacked to form a sixth color photoresist 110. Such the stacked manner is that the sub-pixels are arranged on the same straight line, or the first color photoresist 105, the second color photoresist 106 and the third color photoresist 107 are connected end to end, forming a circular or rectangular. This can be achieved that each photoresist within the same pixel is stacked another another.

Further, in the sub-pixel stacking photoresists, the upper and lower orders and the thicknesses of the two photoresists can be arbitrarily selected according to actual demand, no restrictions.

Different from the case of the prior art, the invention is by stacking any two of the conventional three color photoresists in each pixel to form the fourth color photoresist. The fourth color photoresist can allow a fourth color to pass through the photoresist so as to increase the LCD's color gamut. Furthermore, the fourth color photoresist is formed by stacking the conventional three color photoresists, adding no new photoresist, simplifying the production process, improving production efficiency, and reducing costs.

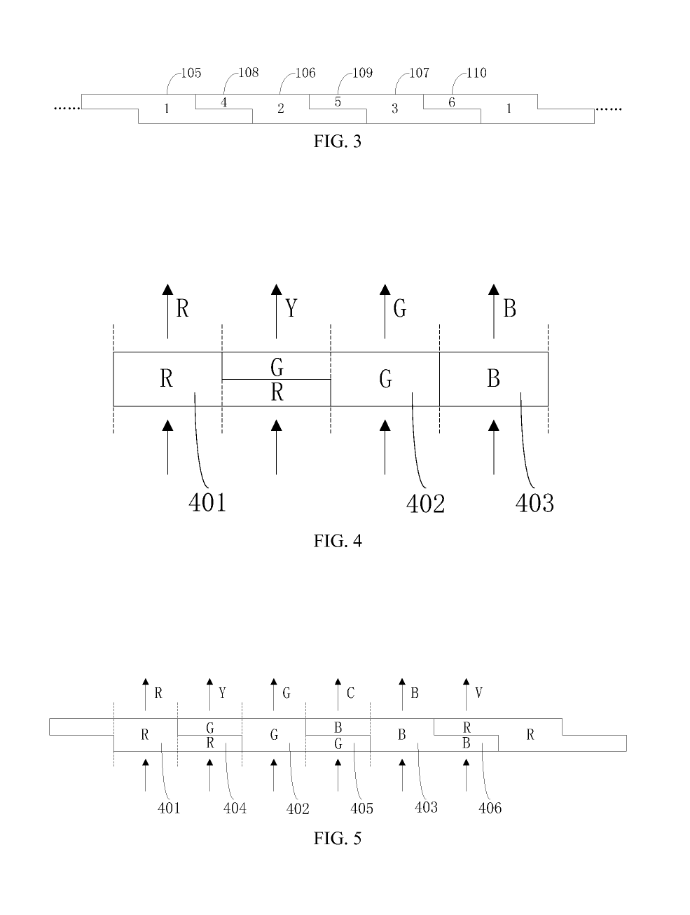

Refer to FIG. 4, a schematic structural view of a color filter substrate of the second embodiment of the invention formed by stacking the red and green photoresists of the red, green and blue color photoresists. The color filter substrate includes a plurality of pixels arranged in an array, and each of the pixels at least includes a first sub-pixel, a second sub-pixel, a third sub-pixel and a fourth sub-pixel.

The first sub-pixel is coated with a red photoresist 401, the second sub-pixel is coated with a green photoresist 402, and the third sub-pixel is coated with a blue photoresist. A photoresist of the fourth sub-pixel is formed by stacking any two of the red photoresist, the green photoresist and the blue photoresist to allow the corresponding one of yellow light, purple light and cyan light to pass through the fourth sub-pixel.

The first sub-pixel, the second sub-pixel, the third sub-pixel, and the fourth sub-pixel are in the same row or the same column. The fourth sub-pixel are located between the first sub-pixel and the second sub-pixel.

The fourth color photoresist may be a yellow photoresist by stacking the red photoresist 401 and the green photoresist 402, a cyan photoresist by stacking the green photoresist 402 and the blue photoresist 403, or a purple photoresist by stacking the blue photoresist 403 and the red photoresist 401. The order of the red photoresist 401, the green photoresist 402, and the blue photoresist 403 may be decided according to the fourth color photoresist stacked as needed. For example, the red photoresist 401 and the blue photoresist 403 are arranged adjacently to give a purple photoresist. If the red photoresist 401, the green photoresist 402 and the blue photoresist 403 have a certain order, the blue photoresist 403 and the red photoresist of the next pixel may be stacked. When the light source illuminates the pixel, the four different photoresists allow four different colors of light through the pixel, forming four different colors.

Refer to FIG. 5, in the present embodiment, six different color photoresists may be formed by stacking any two of three kinds of photoresists. Each photoresist has a front end extending portion and a rear end extending portion. Each front end extending portion and the rear end extending portion of the former photoresist are stacked.

The yellow photoresist 404 is formed by stacking the red photoresist 401 and the green photoresist 402. The cyan photoresist 405 is formed by stacking the green photoresist 402 and the blue photoresist 403. The purple photoresist 406 is formed by stacking the blue photoresist 403 and the red photoresist 401. When the light source illuminates the pixel, the six different photoresists allow six different colors of light through the pixel, forming six different colors.

Different from the case of the prior art, the invention is by stacking any two of the red, green and blue photoresists to form the fourth color photoresist. The fourth color photoresist can allow one of the yellow, purple and cyan colors to pass through the photoresist. There are four colors, and different brightness of each color is mixed with each other so as to increase the LCD's color gamut. Furthermore, the fourth color photoresist is formed by stacking the conventional three color photoresists, adding no new photoresist, simplifying the production process, improving production efficiency, and reducing costs.

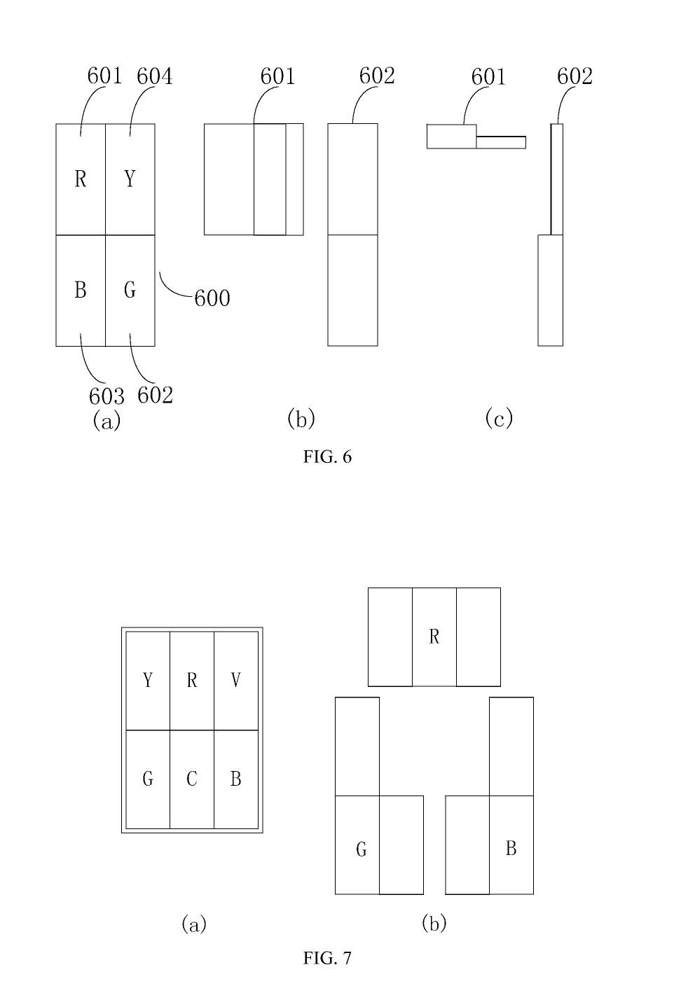

Refer to FIG. 6, a schematic structural view of a color filter substrate of the third embodiment of the present invention. The color filter substrate includes a plurality of pixels arranged in an array, and each of the pixels at least includes a first sub-pixel, a second sub-pixel, a third sub-pixel and a fourth sub-pixel.

The first sub-pixel is coated with a red photoresist 601, the second sub-pixel is coated with a green photoresist 602, and the third sub-pixel is coated with a blue photoresist 603. A photoresist of the fourth sub-pixel is formed by stacking any two of the red photoresist, the green photoresist and the blue photoresist to allow the corresponding one of yellow light, purple light and cyan light to pass through the fourth sub-pixel.

The the first sub-pixel, the second sub-pixel, the third sub-pixel, and the fourth sub-pixel form a square. The first sub-pixel and the second sub-pixel are located on a diagonal line of the square

As FIG. 6 (b) and FIG. 6 (c), the shaded portions of the red photoresist 601 and the green photoresist 602 are stacked on each other, forming a yellow photoresist 604.

The present embodiment is not limited to the stack of the red photoresist 601 and the green photoresist 602 in FIG. 6. The stack may be of the green photoresist 602 and the blue photoresist 603, or the blue photoresist 603 and the red photoresist 601.

As shown in FIG. 7, the present embodiment can also stack three different colors in the manner shown in FIG. 7. The shape of each photoresist shown in FIG. 7 (b) is formed by stacking the same shaded patterns together to form six color photoresists as shown in FIG. 7 (a).

Further, the shape of each pixel is not limited to a rectangle in FIG. 6, may be square, parallelogram and other shapes.

This embodiment is similar to the embodiments described above, only changing the photoresist arrangement, and not repeated here.

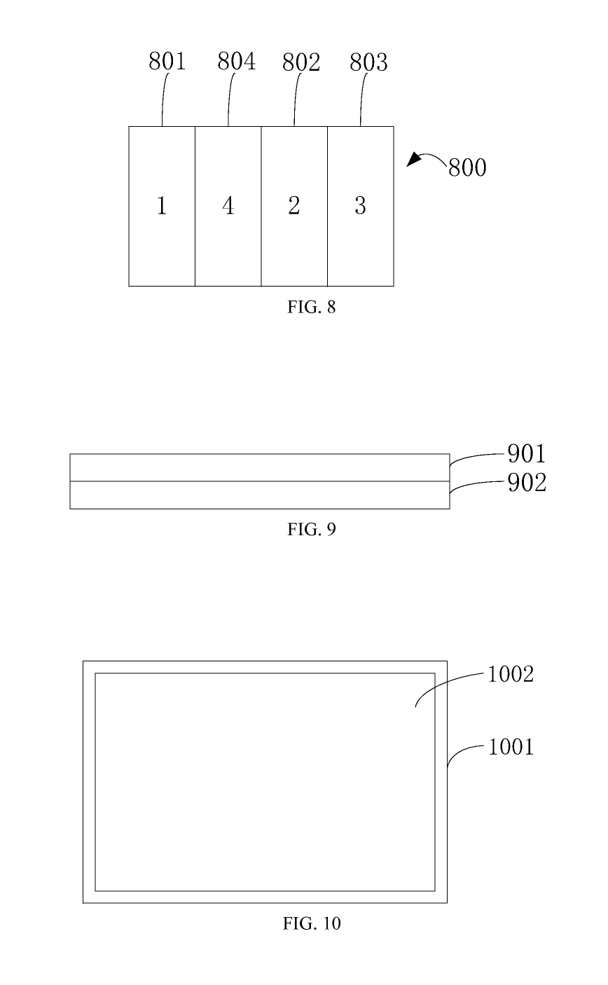

Refer to FIG. 8, a schematic structural view of a color filter of the first embodiment of the invention. The color filter includes a plurality of pixels 800 arranged in an array, and each of the pixels 800 at least includes a first sub-pixel, a second sub-pixel, a third sub-pixel and a fourth sub-pixel.

The first sub-pixel is coated with a first color photoresist 801, the second sub-pixel is coated with a second color photoresist 802, and the third sub-pixel is coated with a third color photoresist 803.

A photoresist 804 of the fourth sub-pixel is formed by stacking any two of the first color photoresist 801, the second color photoresist 802 and the third color photoresist 803.

Of course, this embodiment can also stack any two of three photoresists to form more stacked photoresists as the above embodiments. The embodiment is similar to the embodiments described above, and not repeated here.

Refer to FIG. 9, a schematic structural view of a display panel of the first embodiment of the invention. The display panel includes a color filter substrate 901 and an array substrate 902.

The color filter substrate 901 is the color filter substrate as the embodiment described above. The array substrate 902 includes a plurality of pixels arrayed in an array. Each pixel includes four sub-pixel regions. The four sub-pixel regions of each pixel and the four sub-pixel regions of the color filter substrate are correspondening respectively.

Each sub-pixel of the array substrate 902 further comprises a thin film transistor having a switching effect.

Refer to FIG. 10, a schematic structural view of a display device of the first embodiment of the invention. The display device includes a frame 1001 and a display panel 1002 in the frame 1001.

The display panel 1002 is the display panel of the above embodiment, and is not repeated here.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter substrate, wherein the color filter substrate includes a plurality of pixels arranged in an array, and each of the pixels at least includes a first sub-pixel, a second sub-pixel, a third sub-pixel and a fourth sub-pixel;
wherein the first sub-pixel is coated with a first color photoresist, the second sub-pixel is coated with a second color photoresist, and the third sub-pixel is coated with a third color photoresist;
wherein a photoresist of the fourth sub-pixel is formed by stacking any two of the first color photoresist, the second color photoresist and the third color photoresist.

2. The color filter substrate according to claim 1, wherein the first color photoresist, the second color photoresist and the third color photoresist respectively use a red photoresist, a green photoresist and a blue photoresist to allow red light, green light and blue light respectively to pass through the first sub-pixel, the second sub-pixel and the third sub-pixel, and the photoresist of the fourth sub-pixel formed by stacking any two of the first color photoresist, the second color photoresist and the third color photoresist allows the corresponding one of yellow light, purple light and cyan light to pass through the fourth sub-pixel.

3. The color filter substrate according to claim 2, wherein the fourth sub-pixel is formed by stacking the photoresist of the first sub-pixel and the photoresist of the second sub-pixel.

4. The color filter substrate according to claim 3, wherein the first sub-pixel, the second sub-pixel, the third sub-pixel, and the fourth sub-pixel are in the same row or the same column.

5. The color filter substrate according to claim 4, wherein the fourth sub-pixel are located between the first sub-pixel and the second sub-pixel.

6. The color filter substrate according to claim 3, wherein the the first sub-pixel, the second sub-pixel, the third sub-pixel, and the fourth sub-pixel form a square.

7. The color filter substrate according to claim 6, wherein the first sub-pixel and the second sub-pixel are located on a diagonal line of the square.

8. The color filter substrate according to claim 1, wherein each of the pixels further includes a fifth sub-pixel and a sixth sub-pixel;
wherein the fifth sub-pixel and the sixth sub-pixel are formed by stacking any two of the first color photoresist, the second color photoresist and the third color photoresist to allow the corresponding one of yellow light, purple light and cyan light to pass through the fifth and sixth sub-pixels, and the fourth pixel, the fifth sub-pixe and the sixth sub-pixel are different one another.

9. The color filter substrate according to claim 8, wherein the first sub-pixel, the second sub-pixel, and the third sub-pixel are in the same row or the same column;
wherein the fourth sub-pixel is formed by stacking the photoresist of the first sub-pixel and the photoresist of the second sub-pixel, the fifth sub-pixel is formed by stacking the photoresist of the second sub-pixel and the photoresist of the third sub-pixel, and the sixth sub-pixel is formed by stacking the photoresist of the third sub-pixel and the photoresist of the first sub-pixel located in another pixel.

10. The color filter substrate according to claim 8, wherein the first sub-pixel, the second sub-pixel, the third sub-pixel, the fourth sub-pixel, the fifth sub-pixel, and the sixth sub-pixel are arranged in two columns and three rows, three columns and two rows;
wherein the fourth sub-pixel is formed by stacking the photoresist of the first sub-pixel and the photoresist of the second sub-pixel, the fifth sub-pixel is formed by stacking the photoresist of the second sub-pixel and the photoresist of the third sub-pixel, and the sixth sub-pixel is formed by stacking the photoresist of the third sub-pixel and the photoresist of the first sub-pixel.

11. A color filter, wherein the color filter includes a plurality of pixels arranged in an array, and each of the pixels at least includes a first sub-pixel, a second sub-pixel, a third sub-pixel and a fourth sub-pixel;
wherein the first sub-pixel is coated with a first color photoresist, the second sub-pixel is coated with a second color photoresist, and the third sub-pixel is coated with a third color photoresist;
wherein a photoresist of the fourth sub-pixel is formed by stacking any two of the first color photoresist, the second color photoresist and the third color photoresist.

12. The color filter according to claim 11, wherein the first color photoresist, the second color photoresist and the third color photoresist respectively use a red photoresist, a green photoresist and a blue photoresist to allow red light, green light and blue light respectively to pass through the first sub-pixel, the second sub-pixel and the third sub-pixel, and the photoresist of the fourth sub-pixel formed by stacking any two of the first color photoresist, the second color photoresist and the third color photoresist allows the corresponding one of yellow light, purple light and cyan light to pass through the fourth sub-pixel.

13. The color filter according to claim 12, wherein the fourth sub-pixel is formed by stacking the photoresist of the first sub-pixel and the photoresist of the second sub-pixel.

14. The color filter according to claim 13, wherein the first sub-pixel, the second sub-pixel, the third sub-pixel, and the fourth sub-pixel are in the same row or the same column.

15. The color filter according to claim 14, wherein the fourth sub-pixel are located between the first sub-pixel and the second sub-pixel.

16. The color filter according to claim 13, wherein the the first sub-pixel, the second sub-pixel, the third sub-pixel, and the fourth sub-pixel form a square.

17. The color filter substrate according to claim 16, wherein the first sub-pixel and the second sub-pixel are located on a diagonal line of the square.

18. A display panel, wherein the display panel includes a color filter substrate and an array substrate;
wherein the color filter substrate includes a plurality of pixels arranged in an array, and each of the pixels at least includes a first sub-pixel, a second sub-pixel, a third sub-pixel and a fourth sub-pixel;
wherein the first sub-pixel is coated with a first color photoresist, the second sub-pixel is coated with a second color photoresist, and the third sub-pixel is coated with a third color photoresist;
wherein a photoresist of the fourth sub-pixel is formed by stacking any two of the first color photoresist, the second color photoresist and the third color photoresist.
